(19) United States
(12) Patent Application Publication
(10) Pub. No.: US 2019/0392357 A1
(43) Pub. Date: Dec. 26, 2019

(54) REQUEST OPTIMIZATION FOR A NETWORK-BASED SERVICE

(71) Applicant: Uber Technologies, Inc., San Francisco, CA (US)

(72) Inventors: Tanvi Surti, San Francisco, CA (US); John Mark Nickels, San Francisco, CA (US); Xinxi Chen, San Francisco, CA (US); Ethan Stock, San Franciscco, CA (US)

(21) Appl. No.: 16/448,412

(22) Filed: Jun. 21, 2019

Related U.S. Application Data
(60) Provisional application No. 62/688,590, filed on Jun. 22, 2018.

(51) Int. Cl. G06Q 10/02; G06Q 10/04; G06Q 50/30; H04W 4/029; H04W 4/40

(52) U.S. Cl. CPC G06Q 10/02; G06Q 10/047; H04W 4/40; H04W 4/029; G06Q 50/30

(57) ABSTRACT

A network system implementing or managing a network-based service is configured to receive a query from a user device, the query indicating a start location and a service location. Based on the start location, service location, and the time of receipt of the query, the network system can determine whether to perform request optimization for the user. In response to determining to perform request optimization and if the user accepts request optimization, the network system can schedule or queue the request for service from the user for processing during an optimization time window. The request optimization can improve the probability that the request from the user is matched with other requests from other users for a rideshare-pooling service class of the network-based service. In some circumstances, the network system can determine to automatically perform request optimization without prompting the user to accept or decline the request optimization.

### RELATED APPLICATION

This application claims benefit of priority to U.S. Provisional Patent Application No. 62/688,590, filed on Jun. 22, 2018, and titled “Request Optimization for a Network-Based Service”; the aforementioned application being hereby incorporated by reference in its entirety.

### BACKGROUND

A network-based service can enable users to request and receive various network-based services through applications on mobile computing devices. The network-based service can match a service provider with a requesting user based on the current location of the service provider and a start location specified by the requesting user or determined based on the current location of the requesting user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system in communication with user devices and provider devices, in accordance with examples described herein;

FIGS. 2A and 2B are flow charts illustrating example methods for performing request optimization for the network-based service, according to examples described herein;

FIGS. 3A to 3E are figures illustrating example user interfaces for the user application, in connection with request optimizations for the network-based service, according to examples described herein;

FIG. 4 is a block diagram illustrating an example user mobile computing device, in accordance with examples described herein; and

FIG. 5 is a block diagram that illustrates a computer system upon which examples described herein may be implemented.

### DETAILED DESCRIPTION

A network system is provided herein that manages a network-based service (e.g., a transport service, a delivery service, etc.) linking available service providers (e.g., drivers and/or autonomous vehicles (AVs)) with requesting users (e.g., riders, service requesters) throughout a given region (e.g., San Francisco Bay Area). In doing so, the network system can receive requests for service from requesting users via a designated user application executing on the users' mobile computing devices (“user devices”). Based on a start location (e.g., a pick-up location where a service provider is to rendezvous with the requesting user), the network system can identify an available service provider and transmit an invitation to a mobile computing device of the identified service provider (“provider device”). Should the identified service provider accept the invitation, the network system can transmit directions to the provider device to enable the service provider to navigate to the start location and subsequently from the start location to a service location (e.g., a drop-off location where the service provider is to complete the requested service). The start location can be specified in the request and can be determined from a user input or from one or more geo-aware resources on the user device. The service location can also be specified in the request.

In determining a service provider to fulfill a given service request, the network system can identify a plurality of candidate service providers to service the service request based on a start location indicated in the service request. For example, the network system can determine a geo-fence surrounding the start location (or a geo-fence defined by a radius away from the start location), identify a set of candidate service providers (e.g., twenty or thirty service providers within the geo-fence), and select a service provider (e.g., based on, for example, the service provider's distance to the start location, the service provider's estimated time of arrival at the start location, the service provider's current route, the service provider's current status, etc.) from the candidate service providers to service the service request. In many examples, the service providers can either accept or decline the invitation based on, for example, the route being too long or impractical for the service provider.

The network-based service can include a number of service classes or service types. For some of the service classes (e.g., referred to herein as “rideshare-pooling”), a given request from a requesting user can be matched with other requests from other users such that a service provider can be identified to fulfill the given request and the other requests. The service provider can, for example, rendezvous with a first user at a first start location of a first request and subsequently rendezvous with a second user at a second start location of a second request before proceeding to the service locations of the first and second requests. In this manner, the service provider can be identified to contemporaneously provide service for the first user and the second user.

Embodiments of the network system described herein can be configured to perform request optimization for the network-based service to improve the probability that the request can be matched with one or more other requests for the network-based service from other users. In one aspect, request optimization can be performed by scheduling the processing of a request to a later time (e.g., during an optimization time window) to improve the probability of matching the requesting user with other users for a rideshare-pooling service class. For example, the requesting user can be matched with a second user such that a service provider is identified to provide service (e.g., a transport service) contemporaneously for both the requesting user and the second user for at least a portion of the requesting user's service. As described above, in the context of a transport service, the identified service provider can rendezvous with the requesting user then rendezvous with the second user (or vice versa), before proceeding to the service locations of the requesting user and the second user. In response to the requesting user accepting request optimization, the requesting user can receive a discount for the requested service or some other benefit. In another aspect, the network system can determine to automatically perform request optimization (e.g., without prompting for the user to accept or decline request optimization) by applying a discounted rate for the requested service if the request is to be received during a period of heightened demand or if there are other pending or live requests from other users that can be matched with the request.

According to embodiments, the network system can receive a service query from the user device. The user application can generate the query as the user interacts with the user application to preview the network-based service before submitting a service request. The query can indicate a start location and a service location and can be generated in response to the user entering the start and service locations via the user application. In response to receiving the query, the network system can determine whether to perform request optimization for the user. In the examples described herein, the network system can intelligently determine whether to perform request optimization on a per-query basis. The determination can be made, at least in part, on the start location, the service location, and the time (e.g., time of reception by the network system) of a given query. The network system can determine to (i) automatically perform request optimization for the user, (ii) to prompt the user to either accept request optimization (e.g., scheduling request processing for a later time in exchange for a discount) or decline request optimization, or (iii) to not proceed with request optimization.

If the network system determines not to perform request optimization, the network system can proceed with request processing (e.g., service provider matching, routing, etc.) without any optimization steps being performed. If the network system determines to automatically perform request optimization, the user can be prompted to request the network-based service without being prompted to accept or decline request optimization. The user interface can allow the user to submit a service request that is associated with reduced costs because the user is attempting to request service during a period of heightened demand (e.g., within a pre-determined optimization time window). If the user proceeds within a specified time period (e.g., within the optimization time window), the network system can automatically apply a discount to the request and attempt to match the request with other requests.

If the network system determines to prompt the user to accept or decline request optimization, the user can be presented with a series of user interfaces to accept or decline request optimization. The requesting user can be prompted to accept request optimization, including a delay in processing the user's request in exchange for a discount for the service to be rendered. The user interfaces can present information (e.g., ETA information, estimated cost, etc.) regarding the network-based service with and without request optimization. The user can then accept or decline request optimization in requesting the network-based service. Should the user accept request optimization, the network system can schedule a request for the user to be processed at a subsequent time during the next optimization time window to improve the probability of the user's request being matched with one or more other requests from other users.

Previous technical approaches in matching users for rideshare-pooling service have many drawbacks. In one aspect, because operations to match users are performed as requests are received, the computational strain on the network system can be significant during peak demand times of the service. For each received request, the network system must perform a number of operations to determine other users with whom the received request can be matched and to identify appropriate service providers to fulfill the received request. In this respect, embodiments provided herein enable the network system to operate more efficiently by performing these operations in batches during request optimization time windows. For instance, by scheduling the processing of users' requests during optimization time windows, the network system can more efficiently process the requests since multiple requests are queued and can be processed contemporaneously. In this manner, the network system can process a higher number of requests during peak demand times than it otherwise would be capable of processing. Accordingly, processing capacity and efficiency of the network system in managing the network-based service is improved. In another aspect, because matching users for the rideshare-pooling service depends on real-time demand of users, during time periods of low demand, the network system may have to perform multiple rounds of processing for a received request before a second user can be matched with the received request. In this aspect, embodiments described herein performing request optimization also improve the efficiency of the network system by queueing the requests for processing at the same time, thereby improving the probability that the received request will match with other requests from other users, and reducing the likelihood that additional processing would have to be performed for the received request. In doing so, embodiments described herein improve the efficiency of the network system by reducing such wasted computing resources. In yet another aspect, embodiments described herein improve user experiences (e.g., by informing users when request processing will be performed—during optimization time windows—and thereby better managing user expectations) and improving the overall efficiency of the service being managed by the network system (e.g., by improving probability of matching a received request with other requests).

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Descriptions

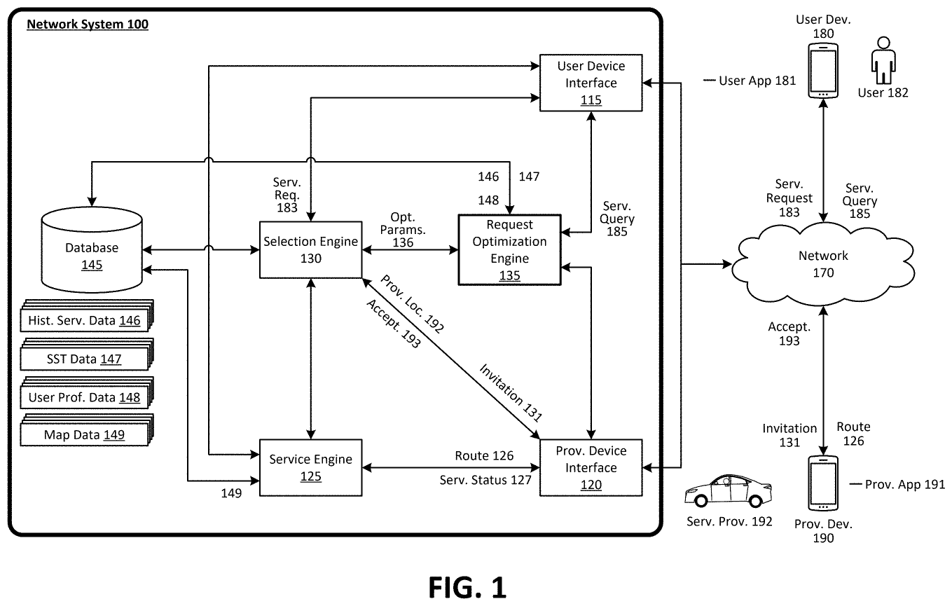

FIG. 1 is a block diagram illustrating an example network system in communication with user devices and provider devices, in accordance with examples described herein. The network system 100 can implement or manage a network-based service (e.g., an on-demand transport service, an on-demand delivery service, etc.) that connects requesting users 182 with service providers 192 that are available to fulfill the users' service requests 183. The network system 100 can provide a platform that enables on-demand services to be provided by an available service provider 192 for a requesting user 182 by way of a user application 181 executing on the user devices 180, and a provider application 191 executing on the provider devices 190. As used herein, a user device 180 and a provider device 190 can comprise a computing device with functionality to execute a designated application corresponding to the on-demand service managed by the network system 100. In many examples, the user device 180 and the provider device 190 can comprise mobile computing devices, such as smartphones, tablet computers, VR or AR headsets, on-board computing systems of vehicles, smart watches, and the like. In one example, a service provider fulfilling a service request includes the service provider rendezvousing with the user at start location (e.g., a pick-up location) to pick up the user and transporting the user to a service location (e.g., a destination location).

The network system 100 can include a user device interface 115 to communicate with user devices 180 over one or more networks 170 via the user application 181. According to examples, a requesting user 182 wishing to utilize the network-based service can launch the user application 181 and transmit a service request 183 over the network 170 to the network system 100. In certain implementations, the requesting user 182 can view multiple different service types managed by the network system 100. In the context of an on-demand transport service, service types can include a ride-share service, an economy service, a luxury service, a professional service provider service (e.g., where the service provider is certified), a self-driving vehicle service, and the like. In certain implementations, the available service types can include a rideshare-pooling service class in which multiple users can be matched to be serviced by a service provider. The user application 181 can enable the user 182 to scroll through the available service types. The user application 181 can also enable the user 182 to enter the start and service locations for a prospective service request. In one aspect, the service query 185 can be generated by the user device 180 in response to the user entering the start and service locations within the user application 181 for a prospective service request 183. The service query 185 can indicate the start and service locations. In response to receiving the service query 185, the network system 100 can provide content data (e.g., content data 133) to cause the user device 180 to display ETA data on a user interface of the user app 181 that indicates an ETA of the closest service provider for the service type, the locations of all proximate available service providers for that service type, and/or the estimated cost for requesting each of the available service types. As the user scrolls through the available service types, the user interface can update to show visual representations of service providers for that service type on a map centered around the user 182 or a start location set by the user. The user 182 can interact with the user interface of the user application 181 to select a particular service type and transmit a service request 183.

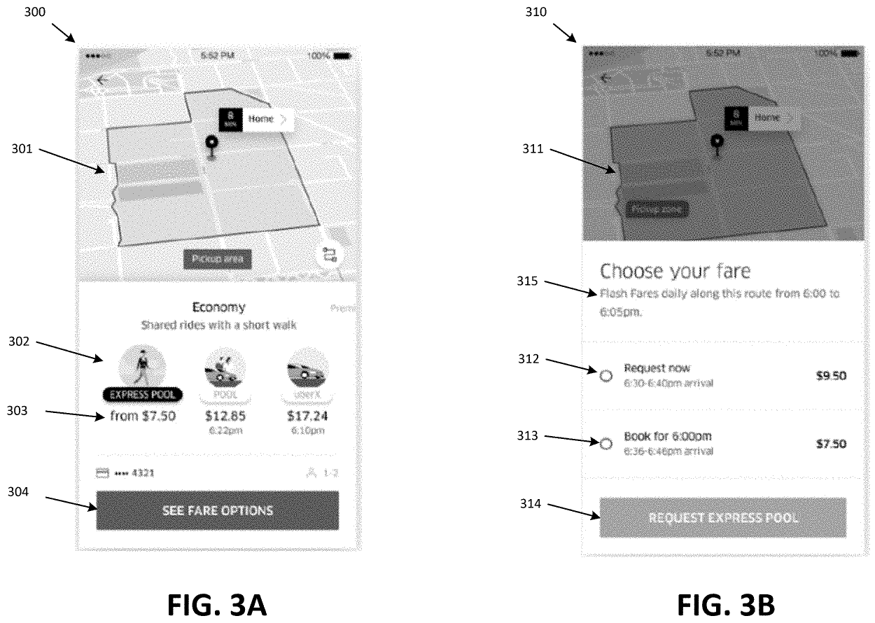

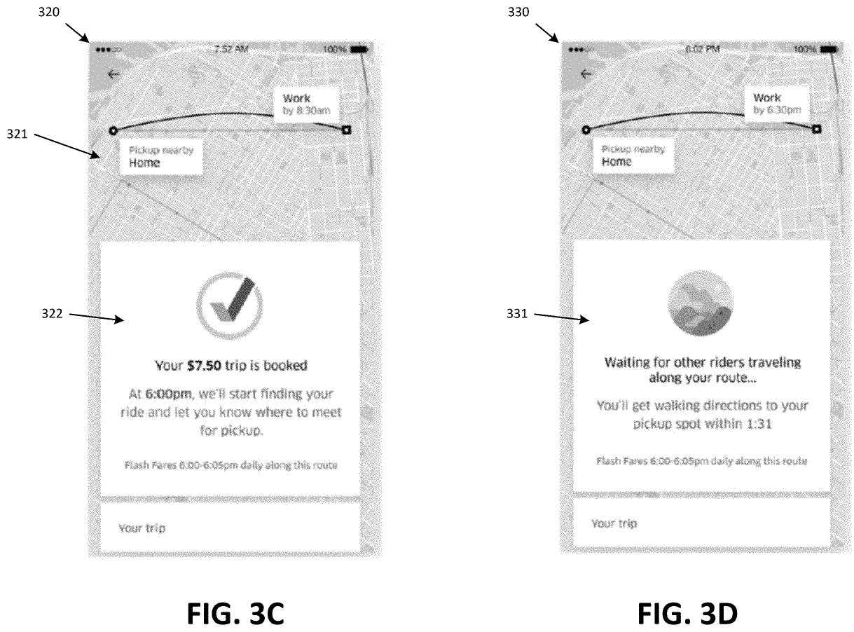

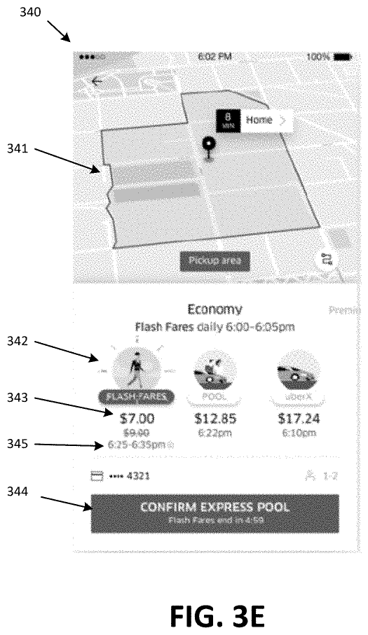

According to embodiments, the network system 100 can include a request optimization engine 135 that can, in response to a service query 185, determine whether to optimize the prospective service request 183 for the user 182. The request optimization engine 135 can determine, on a per-query basis, whether the user 182's prospective request 183 should be optimized for at least the rideshare-pooling service class. Thus, as the user 182 interacts with the user application 181 to preview details about the user 181's prospective service request 183 (e.g., before submitting the request 183), user 181 can view information relating to the request optimization such that the user 181 can accept or decline the request optimization process. If the request optimization engine 135 determines not to optimize the prospective request 183, the network system 100 can proceed with normal processing of the request 183 once it is received. In other words, the user 181 can view the ETA and cost information of the rideshare-pooling service class without any request optimization. On the other hand, if the request optimization engine 135 determines to optimize the prospective request 183, the user 182 can be presented with at least one option to proceed with submitting the request 183 for the rideshare-pooling service class with request optimization and another option to proceed with submitted the request 183 for the rideshare-pooling service class without request optimization. For instance, the user 182 can view respective ETA and cost information for each of the options and can be presented with user interface features to proceed with the request 183 either with or without request optimization. Such an example can be seen in the screenshot of an example user interface illustrated in FIG. 3B.

According to embodiments, the request optimization engine 135 can determine whether to optimize the prospective request 183 based at least in part on the SST (start location-service location-time) of the service query 185. The start and service locations can be indicated by the service query 185 and the time of the query 185 can be the time the service query 185 was received by the network system 100 or the time the query 185 was transmitted by the user device 180.

In one implementation, the network system 100 can include a database 145 that stores SST data 147. The SST data 147 can correspond to a predetermined set of SST combinations for which request optimization is to be performed. Upon receiving query 185, the request optimization engine 135 can determine whether the SST of the query 185 corresponds to one of the predetermined set of SST combinations of the SST data 147 in order to determine whether to perform request optimization for a prospective request (e.g., request 183) resulting from query 185. The set of SST combinations can be defined by an administrator of the network system 100 and/or can be generated by the network system 100 (e.g., based on analyzing historical data associated with the network-based service such as historical service data 146 stored in database 145). In addition to or as an alternative, the request optimization engine 135 can, in response to receiving the query 185, dynamically determine whether to perform request optimization for the prospective request 183 resulting from query 185. In some implementations, the SST data 147 can correspond to predetermined optimization time windows for a given start location and a given service location. The network system can determine whether to perform request optimization based on whether the query was received during or within a threshold time value of an optimization time window for the given start location and the given service location.

The database 145 can further store user profile data 148. Each user (e.g., user 182) can have a corresponding user profile stored within the database 145. The user profile data 148 of the user 182 can indicate, for example, past service requests by the user 182, the user 182's stored payment options, and the user 182's frequent or saved locations (e.g., work, home, etc.). In some implementations, the user profile data 148 of the user 182 can further indicate the user 182's history of accepting or declining request optimization. The request optimization engine 135 of the network system 100 can determine to perform request optimization based on such data. For example, if the user profile data 148 indicates that the user 182 consistently declines request optimizations, the network system 100 and/or the user application 181 can determine to not perform request optimization in response to requests from the user 182.

In various aspects, if the request optimization engine 135 determines to proceed with request optimization in response to the query 185, the request optimization engine 135 can generate optimization parameters 136. The request optimization parameters 136 can include an optimization time window and a discount rate. Based on the optimization parameters 136, a selection engine 130 of the network system 100 can determine information relating to the request optimization such as an ETA to the service location and an estimated cost for the user 182 should the user accept request optimization. The network system 100 can generate content data 133 that is transmitted to the user device 180 to cause the user device 180 to display, within the user application 181, information relating to the request optimization such that the user 182 can make an informed decision as to whether to accept or decline request optimization. As the user makes a selection to proceed to requesting a service provider for the network-based service (e.g., whether with or without request optimization), the user device 180 transmits a service request 183 to the network system 100.

According to embodiments, the network system 100 can include a selection engine 130 that can, in response to receiving the service request 183 from the user device 180, identify a candidate service provider 192 to fulfill the service request 183. If the request 183 is to be optimized (e.g., based on user's accepting of request optimization), the selection engine 130 can schedule to perform the service provider identification process at a later time (e.g., during the optimization time window). The candidate service provider 192 can be identified based on the service provider 192's location relative to a start location of the requested service (e.g., distance to the service location, ETA to the service location, etc.), the service provider 192's availability, a service class associated with service provider 192 (e.g., a ride-share service, an economy transport service, a luxury transport service, a large-capacity transport service, etc.), and the like. In the context of an on-demand transport service, the start location can be a pick-up location where the service provider 192 is to rendezvous with the requesting user 182. In some examples, the start location can be identified in the service request 183. The requesting user 182 can input the start location as an address or by setting a location pin on a map interface of the user application 181. The start location can also be automatically set as the current location of the requesting user 182 (e.g., utilizing location-based resources of the user device 180). As another example, in the context of an on-demand delivery service, the start location can be a restaurant or vendor from which goods are to be picked up by the service provider 192 for delivery to the requesting user 182.

In various aspects, the selection engine 130 can transmit an invitation 131 to fulfill the service request 183 to the provider device 190 of the identified candidate service provider 192 via the provider device interface 120. In response, the provider application 191 can display a prompt for the service provider 192 to accept or decline the invitation 131. Should the service provider 192 accept the invitation 131, the provider application 191 can cause the provider device 190 to transmit an acceptance 193 to the network system 100. In response to receiving the acceptance 193 from the provider device 190, the network system 100 can perform a series of operations to facilitate the fulfillment of the requested service by the service provider 192. For instance, the network system 100 can include a service engine 125 that can generate an optimal route 126 for the service provider 192 in fulfilling the service request 183. The route 126 can be generated based on map data 149 stored within the database 145. The route 126 can include a segment from the current location of the service provider 192 to the start location associated with the service request 183 and a segment from the start location to the service location associated with the service request 183. The route 126 can also include other intermediate locations such as a drop-off location for another user of a ride-share transport service, etc. The provider device interface 120 can transmit the route 126 to the provider device 190 via the one or more networks 170.

In various implementations, the selection engine 130 is configured to match a plurality of users' requests for at least the rideshare-pooling service class. As a result, the service provider 192 can be identified by the selection engine 130 to fulfill a plurality of service requests from a plurality of users, including request 183 from user 182. The requests can be matched based on their respective start and service locations. For instance, another request can be matched with request 183 to be serviced by the same service provider 182 based on a similarity of their respective routes. In addition, the selection engine 130 can be configured to adjust the start location and/or the service location of request 183 during the service provider selection process. For example, the selection engine 130 can identify a more optimal start location that would result in less detour from an existing route for service provider 182. The network system 100 can transmit data to the user device 180 to cause the user device 180 to display walking directions for the user 182 to the more optimal start location.

Methodology

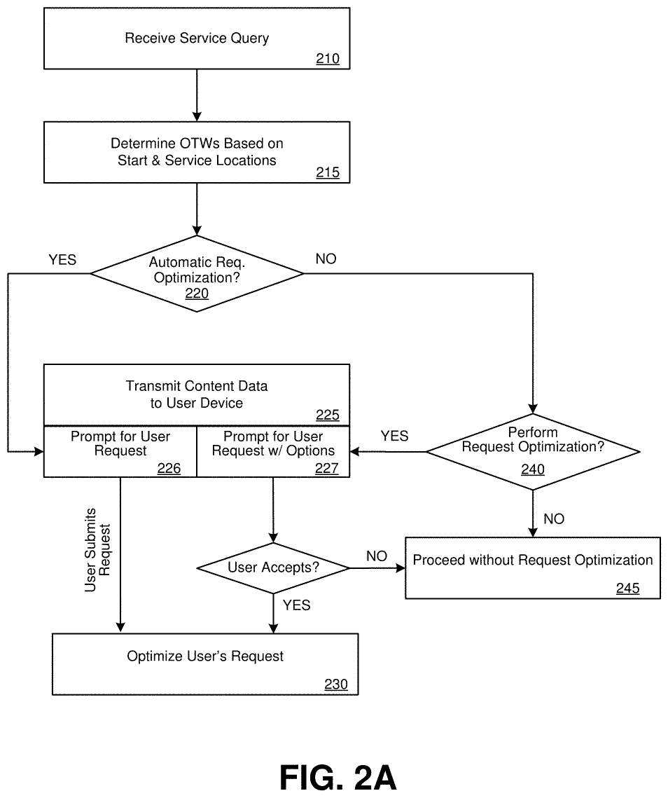

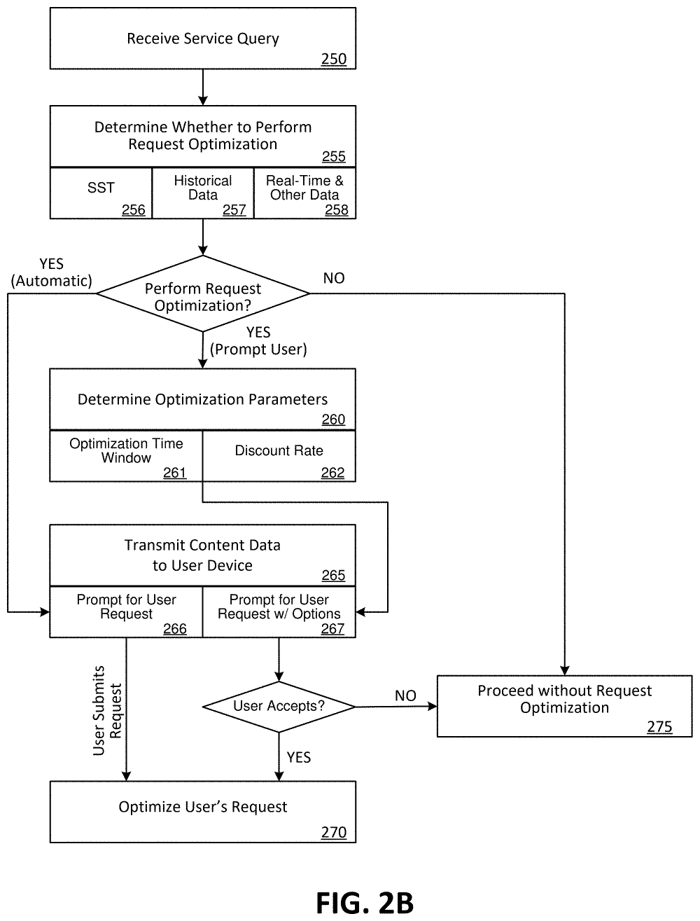

FIGS. 2A and 2B are flow charts illustrating example methods for performing request optimization for the network-based service, according to examples described herein. In the below discussion of FIGS. 2A and 2B, reference may be made to features and examples shown and described with respect to FIG. 1. For instance, the example methods illustrated in and described with respect to FIGS. 2A and 2B can be performed by a network system such as network system 100 and/or a user device such as user device 180, both illustrated in and described with respect to FIG. 1.

Referring to FIG. 2A, the network system receives data corresponding to a service query from a user device over a network (210). The query can indicate a start location and a service location. The query can be generated by the user device in response to the start and service locations being entered within the user application for the network-based service. The start and service locations can be entered via a number of ways. For instance, the start location can be automatically entered by the user application using location data generated by one or more location-aware resources (e.g., GPS, GLONASS, Galileo, BeiDou receivers, etc.). The start and service locations can also be entered by the user via an input prompt. The user can enter the locations as a landmark name, a point of interest, an address, or an intersection. Alternatively, the user can input the locations via a map interface of the user application by locating a “pin” within the map interface. In various implementations, the user application can cause the user device to automatically transmit the query data to network system in response to the start and service locations being entered. Thus, the network system can receive the query data prior to a request for service being received from the user device.

In response to receiving the query, the network system determines potential optimization time windows for the user based on the start and service locations (215). For example, the network system and/or a system administrator can pre-determine a schedule of optimization time windows for service between the start location and the service location. An optimization time window can represent periods of heightened demand for the network-based service such that the opportunity for matching multiple users for the rideshare-pooling service class is increased. Requests that are optimized by the network system are processed (e.g., matched with a service provider and other users) during optimization time windows. The optimization time windows can be pre-determined based on historical data associated with the network-based service that indicates times of peak demand (e.g., rush hour, etc.). The optimization time windows can also be dynamically determined based on historical or real-time data associated with the network-based service (e.g., data indicating historical or real-time demand for the network-based service, etc.) as described herein. In various implementations, the user application can publish or display the schedule of optimization windows for the route between the start location and the service location.

According to embodiments, the network system can determine whether to automatically perform request optimization (220). The determination can be made based on the start location, service location, and time (SST) of the query. For instance, the network system can compare the time at which the query was transmitted or received with the optimization time windows determined in step 215 to determine whether to automatically perform request optimization. In one implementation, the network system can determine to automatically perform request optimization if the query was received during an optimization time window. As an example, the user interacts with the user application to generate a query at 6:01 PM indicating a start location of his or her work address and a service location of his or her home address. Based on the start and service locations, the network system can determine a plurality of optimization time windows for the start and service locations, including one from 6:00 PM to 6:05 PM. Because the query was received during an optimization time window, the network system can determine to automatically perform request optimization provided that the request resulting from the query is transmitted before the optimization time window ends at 6:05 PM.

After step 220, the network system can transmit content data to the user device (225) to cause the user device to display, within the user application, user interfaces to allow the user to continue with requesting the network-based service. If the network system determined to automatically perform request optimization at step 220, the network system can transmit content data to cause the user device to prompt for the user to submit the request for service (226). An example of such a user interface is illustrated in and described with respect to FIG. 3E. Because the request is automatically optimized by the network system, the user is not provided with an option to decline request optimization. Once the user submits the request, the network system proceeds to optimize the user's request (230) by matching the user's request with a service provider and/or other requests from other users. Furthermore, because the request is automatically optimized by the network system, the cost to the user for the requested service is reduced.

If the network system determines at step 220 to not automatically perform request optimization, the network system can additionally determine whether to perform request optimization (240). This determination can also be made based on the SST of the query. In one example, the network system can compare time of the query with the next available optimization time window for the network-based service between the start location and the service location. If the time of the query is within a threshold time of the next available optimization time window, the network system can determine to proceed with request optimization (e.g., step 227 as described herein). Otherwise, the process can proceed without request optimization (245). As an example, the query can be received at 4:00 PM. The network system can determine that the next available optimization time window for the given start and service locations is 6:00 PM to 6:05 PM. The network system can determine to not proceed with request optimization because the two-hour time difference to the next available optimization time window is greater than the threshold time value (e.g., 20 minutes). In another example, the query can be received at 5:45 PM for the same start and service locations. In this case, the network system can determine to proceed with request optimization because the time of the query is within the threshold time value of the next available optimization time window (6:00 PM to 6:05 PM). Thus, the threshold time value can be a maximum amount of time the user can be expected to accept in the delay of the processing of the user's request for service during the optimization process.

According to embodiments, the determination at step 240 can also be based on real-time and historical data. For instance, the threshold time value can be dynamically adjusted based on real-time and/or historical data associated with mass transit services available to the user. As an example, the network system can retrieve real-time data indicating that a bus service available to the user from the start location and the service location to dynamically adjust the threshold time value. If the bus service has a real-time wait time (e.g., ETA to a stop near the start location) of ten minutes, the network system can dynamically adjust the threshold time value from twenty minutes to ten minutes so that the user will not be expected to experience a wait time associated with request optimization that is longer than the wait time for the bus service.

If the network system determines at step 240 to not perform request optimization, the process can proceed without request optimization (245). If the network system determines to perform request optimization, the network system can transmit data to the user device to cause the user device to display, within the user application, user interfaces to allow the user to either accept or decline request optimization while submitting the request for service (227). Examples of such user interfaces are illustrated in and described with respect to FIGS. 3A and 3B. If the user declines request optimization, the process can proceed without request optimization (245). If the user accepts request optimization, the network system can optimize the user's request by queueing or scheduling the request for processing (e.g., service provider matching, etc.) during the next available optimization window (230). In addition, the network system can apply a discount rate to the cost for the user for the requested services.

FIG. 2B illustrates another example method for performing request optimization for the network-based service, according to examples described herein. The example method can begin when the network system receives query data over a network (e.g., the Internet) from a user device (250). This can be performed in a similar fashion as described with respect to step 210 in FIG. 2A. In other embodiments, the network system and/or user application can be configured such that the example method begins with a request for service being received from the user device.

In response to receiving the query data, the network system can determine whether to proceed with request optimization for a prospective request that follows the received query (255). At a high-level, the network system can intelligently determine whether to proceed with request optimization on a per-query basis. This determination can be based on the start location-service location-time (SST) of the received query (256). In one implementation, the network system can include a database storing a predetermined set of SST combinations for which request optimization is to be performed. Upon receiving a given query, the network system can determine whether the SST of the given query corresponds to one of the predetermined set of SST combinations in order to determine whether to perform request optimization for the given request. The set of SST combinations can be defined by an administrator of the network system and/or can be generated by the network system. The set of SST combinations can also be periodically updated. In other implementations, rather than predetermining a set of SST combinations, the network system can dynamically perform the determinations based on the SST of a given request. In other examples, the network system (or an administrator of the network system) can predetermine certain SST combinations for triggering request optimizations. For requests that do not match to any predetermined combinations, the network system can perform a dynamic determination based on the SSTs of the requests to determine whether request optimizations should be performed for those requests.

The determination of whether to perform request optimization can also be made based on historical data relating to the network service (257). For instance, the network system can determine whether to proceed with request optimization based on historical data indicating an expected number of other users' requests with which the given request can be matched for the rideshare-pooling service (e.g., having a similar start location, service location, and time as the given request). The historical data can be generated and maintained by the network system in managing the network-based service. Based on historical data indicating that the typical number of such requests from other users is above a minimum threshold value and/or below a maximum threshold value, the network system can identify the given start location and the given service location as one of the start-service location pairs for the given time period. If the expected number of other requests is below a minimum threshold (e.g., indicating a low probability of being successfully matched with other requests), the network system can determine to forgo request optimization (e.g., because request optimization may yield no meaningful benefit to the user or the service provider). On the other hand, if the expected number of other requests is above a maximum threshold (e.g., indicating a high probability of being successfully matched with other requests), the network system can also determine to forgo request optimization because there may not be a need to optimize the request since the probability of the request being matched with other requests is already high. But if the expected number of other requests is between the minimum and maximum thresholds, the network system can determine to optimize the given request by offering to delay the processing of the given request in order to improve the probability that the given request can be matched with other requests.

As one example, the network system can analyze historical data (e.g., database of completed service logs, etc.) relating to past service requests requesting service from the Nob Hill District to the Financial District of San Francisco at around 8:30 AM on Mondays. Based on the historical data, the network system can estimate the typical number of users requesting service having such an SST (Nob Hill; Financial District; Monday, Mondays, 8:30 AM). If this estimated number satisfies one or more criteria (e.g., above a min threshold and/or below a max threshold), the network system can identify the SST combination (Nob Hill; Financial District; Monday, Mondays, 8:30 AM) as one of the predetermined set of SSTs for which request optimization is to be performed. Thus, in response to a user requesting service from a location within the Nob Hill District to a location within the Financial District at around 8:30 AM, the network system can perform a query to determine the request as corresponding to one of the predetermined set of SSTs and, in response, determine to perform request optimization for this request. As an alternative, the network system can dynamically perform the SST determination for Nob Hill District to the Financial District at Monday 8:30 AM in response to a request from a user. As can be appreciated, the SST determination can have different granularities in terms of the start and service locations. In other examples, the SST determination can be made for geographically smaller areas (e.g., a city block within Financial District, a few city blocks within Nob Hill District, etc.) or geographically larger areas (e.g., all of San Francisco, etc.), depending on parameters such as the location, population density, etc.

Additionally, the determination of whether to perform request optimization can be made based on real-time and other data (258). For instance, the network system can determine, based on real-time data relating to the network-based service, whether to optimize a prospective request resulting from the received query based on a number of other requests currently pending or being processed by the network system that have SSTs that match (or are sufficiently similar to) the SST of a query received by the network system. In one example, the network system can receive a first request requesting service from a location near in SoHo in New York City (start location) to a location near Times Square. In response to receiving the first request, the network system can determine the number of other requests from other users that are pending or currently being processed by the network system that have a start location in SoHo and a service location near Times Square. The other requests can include a request for service being scheduled ahead of time by another user such that the requested service is to be rendered at or around the time the first service request was received by the network system. The other requests can also include a request that the network system is currently matching with available service providers. In addition, the other requests can further include a request that has been optimized and therefore is being queued for service provider matching at a later time. The other requests can also include requests for which a service provider has already been matched. In such cases, the route of the service provider can be taken into account in determining whether to perform request optimization for the first request.

In various examples, the SST determination can also be made based on data that is external to the network-based service. Such relevant data can include information relating to events (e.g., sporting events, concerts, etc.) that may affect the expected number of users that will request service from or to a particular location at a particular time. For example, in response to receiving a given request requesting service from a concert venue (start location), the network system can determine, based on data external to the network-based service, that a concert is ending in approximately 10 minutes and, as a result, the expected number of users will increase significantly in 10 minutes. In response, the network system can determine to optimize the given request to prompt for the user's permission in delaying the processing of the request to improve the probability of the given request matching one or more other requests. The relevant data external to the network-based service can also include real-time traffic data, data relating to mass transportation (e.g., transit schedules, transit delays, etc.), map data that can indicate points of interests, and the like.

According to embodiments, the network system can further determine whether to perform request optimization based on data associated with the user. The network system and/or user application executing on the user device can learn and adapt to a given user's behavior with respect to request optimizations. In one aspect, the network system and/or the user application can determine, based on user profile data indicating the given user's past actions in accepting or declining request optimizations, whether to perform request optimization for a given request submitted by the given user. Thus, if the given user consistently declines request optimizations, the network system and/or the user application can determine to not perform request optimization in response to requests from the given user. The determination can also be more specific and even more personalized. For instance, user profile data for the user can indicate differing preferences with respect to accepting or declining request optimizations for different SSTs and the determination to perform request optimization can be made accordingly. As one example, the given user may consistently accept request optimization for services from Nob Hill to Financial District if requested before 8:30 AM on weekdays but also may consistently decline request optimization for the same trip if the request is submitted after 9:30 AM on weekdays. Based on user profile data indicating the above, the network system and/or the user application can determine to perform request optimization for requests submitted by the user for service from Nob Hill to Financial District before 8:30 AM and determine to not perform request optimization for requests submitted by the user after 9:30 AM.

In another aspect, the network system can analyze the profile data of a given user to determine patterns in the given user's use of the network-based service to proactively prompt the user of request optimization possibilities without having received a query from the user device. For instance, the network system can determine by analyzing the user profile data that the given user frequently travels during weekday morning rush hours from the user's home to the user's workplace. Based on this determination, the network system can transmit data to the user device to cause the user device to display one or more push notifications regarding request optimizations for the frequent trip taken by the given user. The push notifications can inform the user that if the user submits a request for service from home to work within a specific upcoming time window (e.g., a determined optimization time window), the user can receive a reduction in cost for the service. The user can interact with the push notification to open the user application to generate such a request within the upcoming time window.

As part of step 255, the network system can determine to automatically perform request optimization. In this context, automatic request optimization can mean proceeding with request optimization without additionally prompting the user to accept or decline request optimization. As an example, automatic request optimization can result in the user being only prompted, within the user application, to submit an optimized request for the rideshare-pooling service, rather than being prompted with options to either submit a request for the rideshare-pooling service with request optimization or submit a request for the rideshare-pooling service without request optimization. The network system can determine to automatically optimize a prospective request if the user fortuitously submits a query at a time of heightened demand such that little to no wait time is expected to match the user's service with one or more other requests for service for other users. As an alternative, the network system can determine whether to perform request optimization after step 260, based on optimization parameters determined during that step. As one example, if the network system determines the optimization time window to be substantially contemporaneous with the time of reception of the query that triggered the optimization process, the network system can determine to automatically perform request optimization without additionally prompting the user to accept or decline request optimization.

According to embodiments, the network system can determine to automatically perform request optimization based on real-time or historical data, such as real-time or historical data indicating times of heightened demand for the network-based service. For instance, based on the starting and service locations indicated in the query, the network system can dynamically determine a number of other requests from other users that can be instantaneously matched with the prospective request from the user. And if that number is above a threshold value, the network system can determine to automatically perform request optimization. As an example, the query can indicate that the user is interested in a rideshare-pooling service from a given start location to a given service location. At step 220, the network system can dynamically determine that two other requests can be matched if the user proceeds to request the service. Such other requests can be determined based on the expected route a service provider would take in the event the requests are matched. For instance, another request having proximate start and service locations as the given start and service locations. In addition, another request having a route that overlaps with the expected route from the given start location to the given service location can also be identified. As an alternative or in addition to, the network system can also determine to automatically perform request optimization if historical data indicates that the prospective request will occur in a period of heightened demand.

If the network system determines not to perform request optimization, the process proceeds without request optimization (275). The user can be prompted to submit conventional, non-optimized request for the network-based service. If the network system determines to automatically perform request optimization, the process can proceed to step 266. If the network system determines to proceed with request optimization but not with automatic request optimization, the process can proceed to step 260 wherein one or more optimization parameters are determined. The one or more optimization parameters determined by the network system can include an optimization time window during which a request for service for the user is to be processed (261). The optimization time window can be the time period during which the service provider matching is performed by the network system. The network system can determine, for a given query, when the optimization window begins as well as the duration of the optimization time window. In one implementation, the network system can determine the begin time and duration of the optimization time window based on historical and real-time data relating to the network-based service. For instance, the network system can determine these parameters based on historical and/or real-time data relating to the network-based service indicating an anticipated (or actual) number of users requesting service between the start location and the service location. If the network system determines a high number of anticipated (or actual) other users requesting service between the start location and the service location, the network system can determine the begin time of the optimization window to be close in time to the time the request was received. In this manner, the user can experience less wait time while still maintaining a high probability that the user's request can be matched with other requests. On the other hand, if the network system determines a low number of anticipated (or actual) other users requesting service between the start and service locations, the network system can determine to delay the begin time of the optimization time window. Similar determinations can be made for the duration of the optimization time window—the duration of the optimization time window can be determined to be longer or shorter based on the anticipated (or actual) number of other users requesting service between the start location and the service location. Still further, the network system can determine the parameters of the optimization time window such that the optimization time window coincides with anticipated times of peak demand (e.g., rush hour). For instance, in determining the optimization parameters of a given request received at 8:50 AM, the network system can analyze the historical data relating to the network-based service to identify an anticipated period of heightened demand from approximately 9:00 AM to 9:20 AM. In response, the network system can determine the optimization time window to be from 9:00 AM to 9:10 AM to coincide with at least a portion of the anticipated period of heightened demand.

In addition or as an alternative, the network system can determine the begin time and duration of the optimization time window based on data external to the network-based service. In one variation, the network system can retrieve data (real-time data and/or historical data) regarding wait-times and schedules for public transit options (e.g., buses, subways, trains, etc.) available to the requesting user between the start location and the service location and determine the begin time and duration of the optimization time window based on such data. Such data can be used as constraints for the optimization time window parameters such that the user will neither expect to wait for longer than the next earliest public transit option nor expect to arrive at the service location later than any public transit options. For example, the network system can determine, based on real-time or historical data relating to the public transit routes available to the user, the begin time of the optimization time window such that a service provider can be identified for the request before than the earliest available public transit option. Furthermore, the network system can further determine the begin time and duration of the optimization time window such that the computed estimated time of arrival for the user at the service location (if request optimization is accepted by the user) is earlier than any of the public transit options available to the user from the start location to the service location.

The one or more optimization parameters can further include a discount rate for the user (262). The discount rate can correspond to a reduction to the cost for the user for the requested service should the user accept request optimization for the request. The discount rate can be a percentage reduction (e.g., 20% reduction) or can be a fixed numerical reduction (e.g., $10 reduction) to the cost for the user for the fulfillment of the requested service. In some implementations, the discount rate can be specifically pre-determined based on the SST. In other implementations, the discount rate can be dynamically computed based on a computed matching probability indicating a likelihood that the user's request will be matched with one or more other requests from other users. Such a matching probability can be computed based on historical data. For example, the network system can determine the probability of matching based on an average or mean matching rate for past requests having a comparable SST. The matching probability can also be computed based on real-time data (e.g., real-time demand data, number of requests in queue or being processed by the network system, and the like). The matching probability can be a multi-dimensional metric—e.g., a matching probability metric computed for a given request can indicate corresponding probabilities for matching with one, two, and three other requests from other users.

At step 265, content data is transmitted to the user device to cause user interfaces to be displayed that prompts the user to submit a request for the network-based service. The content data transmitted to the user device and the user interfaces that are displayed on the user device can depend on whether the network system determined to automatically perform request optimization.

If the network system determined to prompt the user to accept or decline the request optimization, the network system can transmit content data and cause the user device to present a user interface that includes a prompt to accept or decline request optimization (267). The prompt can include a first estimated time of arrival at the service location and a first cost for requesting the network-based service associated with accepting request optimization, and a second estimated time of arrival at the service location and a second cost for requesting the network-based service associated with declining request optimization. An example user interface including such a prompt can be seen in FIG. 3B. Thus, the user interface allows the user to make an informed decision whether to accept or decline request optimization for the network-based service from the start location to the service location.

Based on the user's response to the prompt to accept or decline request optimization, the process can proceed. If the user accepts request optimization, the network system can schedule to optimize the request in accordance with the determined optimization parameters (270). For instance, the network system can perform service provider matching for the user during the optimization time window and apply the discount rate to the user's cost for the requested service. In addition, the network service can adjust the start and service locations for the requested service based on the optimization parameters determined at step 260. On the other hand, if the user declines request optimization, the network system can proceed with processing the request without request optimization (275).

If the network system determined to automatically perform request optimization, the user can be presented with a user interface such as the one illustrated and described with respect to FIG. 3E to the user (266). Instead of being prompted with options to proceed with requesting the service with and without request optimization, the user can simply be prompted to submit an optimized request for service having a reduced cost due to the optimization. In other words, the user interface presented to the user does not include the prompt to accept or decline request optimization. The user interface can inform the user of the reason for the reduction in cost such that, in the future, the user can continue to submit requests at times of heightened demand. Once the user submits a request via the user interface, the network system can proceed with optimizing the request (275), such as applying the discount to the cost of the service for the user and matching the user's request with other requests.

According to embodiments, in matching the user's request with other users' requests as part of request optimization, the network system can be configured to determine more optimal start and/or service locations for the request. Such more optimal locations can be determined to minimize the route of the identified service provider or improve an ETA to one or more service locations. The network system can transmit content data to the user device to cause the user device to present user interfaces to guide the user (e.g., via turn-by-turn walking directions) to the more optimal start location.

User Interface

FIGS. 3A to 3E are figures illustrating example user interfaces for the user application, in connection with request optimizations for the network-based service, according to examples described herein. The user interfaces illustrated in these figures can be presented on the user device, such as user device 180 of FIG. 1, as the user interacts with the user application for the network-based service.

FIG. 3A illustrates an example user interface 300 that can be presented within the user application to allow the user to preview the network-based service prior to submitting a service request. The user interface 300 can display information such as ETA and respective cost information for different service classes of the network-based service. The network system 100 of FIG. 1 can transmit content data to the user device to cause the user device to display the user interface 300. The user can first interact with the user application to enter a start location and a service location. In response, the user device can transmit a service query to the network system. In response to receiving the query, the network system can perform functions described with respect to FIGS. 1 and 2 to determine whether to perform request optimization and transmit content data to the user device to cause the user device to display the user interface 300.

User interface 300 can be presented after the network system determines that the user should be prompted to accept or decline request optimization. For instance, the user interface 300 can be presented at step 242 of FIG. 2. The user interface 300 can include a map feature 301 displaying a map view of the start location entered by the user for a prospective service request. The map feature 301 can display a region in which the user can be expected to walk to rendezvous with the service provider. In some situations, the network system can determine a more optimal start location within this region for matching the user with other service requests (e.g., based minimizing detours for a service provider along an existing route). The user can select from a plurality of service classes of the network-based service via user interface 300. For example, the user can select a rideshare-pooling service class via selection feature 302. The selection feature 302 can further include a cost estimate 303 for the rideshare-pooling service. Because the user is to accept or decline request optimization, the cost estimate 303 can display the estimated cost of network-based service with request optimization and include a notice that the cost can be higher without request optimization (e.g., “from $7.50”). The user interface 300 can further include a feature 304 with which the user can interact to proceed to the next step in requesting the network-based service. If the rideshare-pooling service selection feature 302 is selected, the user can be presented with a user interface to either accept or decline request optimization. An exemplary such user interface is illustrated in and described with respect to FIG. 3B.

FIG. 3B illustrates an example user interface 310 that can be presented within the user application to allow the user to accept or decline request optimization before submitting the request for service. The user interface 310 can be displayed in response to the user proceeding from the user interface 300 by interacting with feature 304. The user interface 310 includes a map feature 311 that, similar to map feature 301, displays a map view of the start location entered by the user for a prospective service request. The user interface 310 further includes selection features 312 and 313 for declining and accepting request optimization, respectively, prior to requesting the network-based service. The selection features 312 and 313 includes information regarding respective ETAs and costs of proceeding with the request for service without and with request optimization, respectively. By selecting one of the selection features 312 and 313 the user can proceed with requesting the network-based service by interacting with feature 314. The user interface 310 can also include a panel 315 that displays information regarding request optimization. The panel 315 can display information regarding the optimization time window (e.g., as illustrated here, 6:00 to 6:05 PM).

FIGS. 3C and 3D illustrate example user interfaces 320 and 330 that can be displayed within the user application after the user accepts request optimization. For instance, immediately after the user submits a request for service while accepting request optimization (e.g., via user interface 310 of FIG. 3B), the user application can display user interface 320 illustrated in FIG. 3C. The user interface 320 can include a map feature 321 for displaying an illustration of the route between the start and service locations of the request. The user interface 320 can further display a panel 322 for conveying additional information with respect to the request to the user. For instance, the panel 322 can display content to inform the user that the request is queued or scheduled for future processing during the optimization time window and that the user will receive additional information once the request is processed. As the optimization time window approaches, the user can be presented with user interface 330 of FIG. 3D. The user interface 330 can include a panel 331 to present content to inform the user that the user's request for service is pending for processing and for the user to expect walking directions to a more optimal service location determined by the network system.

FIG. 3E illustrates another example user interface 340 that can be presented within the user application to allow the user to preview the network-based service prior to submitting a service request. Like the user interface 300, the user interface 340 can display information such as ETA and respective cost information for different service classes of the network-based service. The user interface 340 can be presented if the network system determines to automatically perform request optimization. The user interface 340 includes a map feature 341 for displaying a map view of the area surrounding the start location. The user interface 340 further includes a selection feature 342 for selecting the rideshare-pooling service class and a cost estimate 343 for requesting the rideshare-pooling service based on the information entered (e.g., start location, service location, etc.). The user interface 340 further includes a feature 344 with which the user can interact with to place a request for the network-based service. If the rideshare-pooling selection feature 342 is selected when the user presses the feature 344 to request service, a request for the rideshare-pooling service class can be transmitted to the network system. The network system can, in response to the request, process the request by performing request optimization as described herein, without additionally prompting the user to accept or decline request optimization. The user interface 340 can further include an ETA estimate 345 for the rideshare-pooling service class. Furthermore, the user interface 340 can display content to inform the user why request optimization is being automatically performed. For example, the user interface 340 can display content to inform the user that the request will be automatically optimized because user is requesting service during an optimization time window or during a period of heightened demand. In some implementations, the user can also view, via the user application, a predetermined schedule for request optimization. For instance, the predetermined schedule can set forth optimization time windows during which the user's request can be automatically optimized by the network system.

Hardware Diagrams

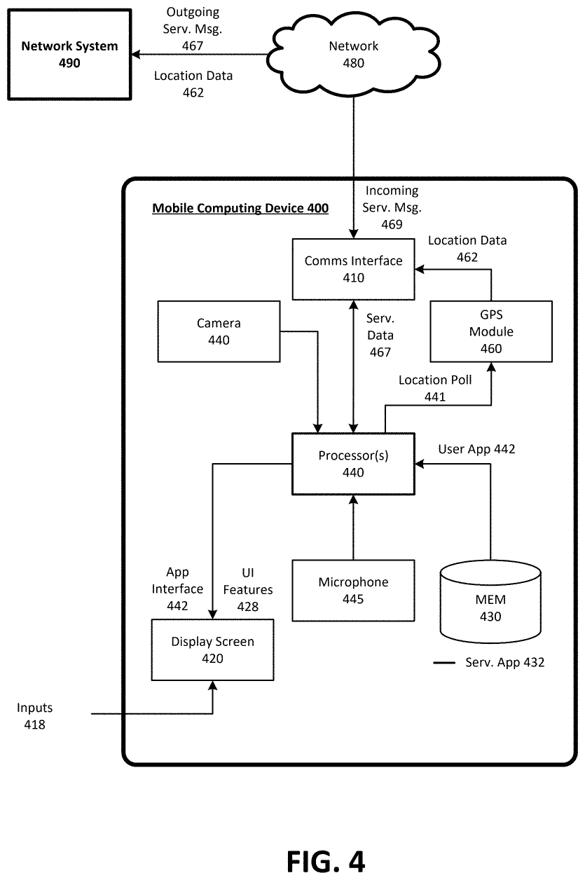

FIG. 4 is a block diagram illustrating an example mobile computing device, in accordance with examples described herein. In many implementations, the mobile computing device 400 can be a smartphone, tablet computer, laptop computer, VR or AR headset device, and the like. In some cases, such as in an autonomous driving vehicle that can fulfill service requests for a network-based service, the mobile computing device 400 can be an on-board computer of the autonomous driving vehicle. In the context of FIG. 1, the user device 180 and/or the provider device 190 may be implemented using a mobile computing device 400 as illustrated in and described with respect to FIG. 4.

According to embodiments, the mobile computing device 400 can include typical telephony features such as a microphone 445, a camera 450, and a communication interface 410 to communicate with external entities (e.g., network system 490 implementing the network-based service) using any number of wireless communication protocols. The mobile computing device 400 can store a designated application (e.g., a service application 432) in a local memory 430. The service application 432 can correspond to one or more user applications for implementations of the mobile computing device 400 as user devices for the network-based service. The service application 432 can also correspond to one or more provider applications for implementations of the mobile computing device 400 as provider devices for the network-based service.

In response to an input 418, the service application 432 can be executed by a processor 440, which can cause an application interface 442 to be generated on a display screen 420 of the mobile computing device 400. In implementations of the mobile computing device 400 as provider devices, the application interface 442 can enable a service provider to, for example, accept or reject invitations to fulfill service requests generated by network system 490. The invitations can be received as incoming service messages 469 and acceptances of the invitations can be transmitting by the mobile computing device 400 to the network system 490 as outgoing service messages 467. In implementations of the mobile computing device 400 as user devices, the application interface 442 can enable a user to, for example, request for the network-based service. The request for service can be transmitted to the network system 490 as an outgoing service message 467.

In various examples, the mobile computing device 400 can include a GPS module 460, which can provide location data 462 indicating the current location of the mobile computing device 400 to the network system 490 over a network 480. In some implementations, other location-aware or geolocation resources such as GLONASS, Galileo, or BeiDou can be used instead of or in addition to the GPS module 460. The network system 490 can utilize the current location 462 of the mobile computing device 400 to manage the network-based service (e.g., selecting service providers to fulfill service requests, routing service providers and users, determining service locations for users, etc.).

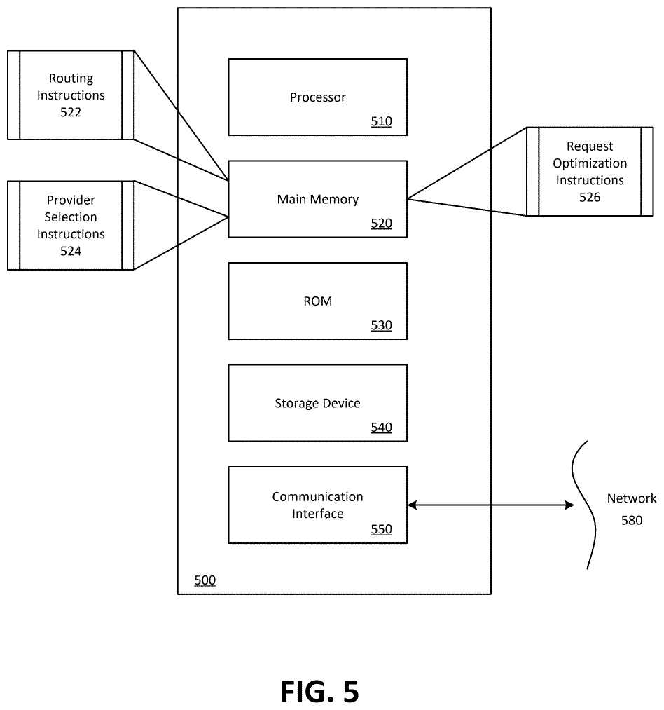

FIG. 5 is a block diagram that illustrates a computer system upon which examples described herein may be implemented. A computer system 500 can represent, for example, hardware for a server or combination of servers that may be implemented as part of a network service for providing on-demand services. In the context of FIG. 1, the network system 100 may be implemented using a computer system 500 or combination of multiple computer systems 500 as described by FIG. 5.

In one aspect, the computer system 500 includes processing resources (processor 510), a main memory 520, a memory 530, a storage device 540, and a communication interface 550. The computer system 500 includes at least one processor 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the memory 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., a cellular network) through use of a network link (wireless or wired). Using the network link, the computer system 500 can communicate with one or more computing devices, one or more servers, and/or one or more self-driving vehicles. In accordance with some examples, the computer system 500 receives service requests from mobile computing devices of individual users. The executable instructions stored in the memory 530 can include routing instructions 522, provider selection instructions 524, and request optimization instructions 526 to perform one or more of the methods described herein when executed.

By way of example, the instructions and data stored in the memory 520 can be executed by the processor 510 to implement an example network system 100 of FIG. 1. In performing the operations, the processor 510 can handle service requests and provider statuses and submit service invitations to facilitate fulfilling the service requests. The processor 510 executes instructions for the software and/or other logic to perform one or more processes, steps and other functions described with implementations, such as described by FIGS. 1 through 3E.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system for managing a network-based service, the network system comprising:
one or more processors; and
one or more memory resources storing instructions that, when executed by the one or more processors of the network system, cause network system to:
receive at a first time, over a network from a user device of a first user, query data corresponding to a query for the network-based service, the query data indicating a start location and a service location;
in response to receiving the query data, determine whether to perform request optimization for the first user based, at least in part, on the start location, the service location, and the first time; and
in response to receiving a first request from the user device of the first user and based on determining to perform request optimization for the first user, perform request optimization for the first user by identifying, at a second time within an optimization time window, a service provider for the first user, wherein the service provider is identified to contemporaneously provide service for the first request and at least a second request for the network-based service from a second user.

2. The network system of claim 1, wherein determining whether to perform request optimization for the first user comprises:
determining the optimization time window based on the start location, the service location, and the first time; and
determining to perform request optimization based on a comparison of the first time and the optimization time window.

3. The network system of claim 2, further comprising determining to perform request optimization based on the first time being within a threshold time value of a start time of the optimization time window.

4. The network system of claim 2, wherein determining whether to perform request optimization for the first user includes determining whether to automatically perform request optimization for the first user based on whether the first time is within the optimization time window.

5. The network system of claim 1, wherein the executed instructions further cause the network system to:
in response to determining to perform request optimization, transmit a set of content data to the user device to enable the user device to present a set of user interface features to enable the first user to either accept or decline request optimization; and
wherein request optimization for the first user is performed in response to receiving data from the user device indicating acceptance by the first user to perform request optimization.

6. The network system of claim 5, wherein the set of user interface features includes a prompt for the first user to either accept or decline request optimization in requesting the network-based service, the prompt displaying (i) a first estimated time of arrival at the service location and a first cost for requesting the network-based service associated with accepting request optimization, and (ii) a second estimated time of arrival at the service location and a second cost for requesting the network-based service associated with declining request optimization.

7. The network system of claim 1:
wherein determining whether to perform request optimization for the first user includes determining whether to automatically perform request optimization for the first user; and
wherein the executed instructions further cause the network system to, in response to determining to automatically perform request optimization for the first user, transmitting a set of content data to the user device to enable the user device to present a set of user interface features to request the network-based service, wherein the set of user interface features does not include a prompt for the first user to decline request optimization.

8. The network system of claim 7, wherein the set of user interface features includes a prompt for the first user to request the network-based service, the prompt displaying an estimated time of arrival at the service location and a cost for requesting the network-based service associated with performing request optimization.

9. The network system of claim 1, wherein determining whether to perform request optimization for the first user is based further on historical data associated with the network-based service.

10. The network system of claim 1, wherein determining whether to perform request optimization for the first user is based further on user profile data associated with the first user.

11. A computer-implemented method for managing a network-based service, the method being performed by a network system and comprising:
receiving at a first time, over a network from a user device of a first user, query data corresponding to a query for the network-based service, the query data indicating a start location and a service location;
in response to receiving the query data, determining whether to perform request optimization for the first user based, at least in part, on the start location, the service location, and the first time; and
in response to receiving a first request from the user device of the first user and based on determining to perform request optimization for the first user, performing request optimization for the first user by identifying, at a second time within an optimization time window, a service provider for the first user, wherein the service provider is identified to contemporaneously provide service for the first request and at least a second request for the network-based service from a second user.

12. The computer-implemented method of claim 11, wherein determining whether to perform request optimization for the first user comprises:
determining the optimization time window based on the start location, the service location, and the first time; and
determining to perform request optimization based on a comparison of the first time and the optimization time window.

13. The computer-implemented method of claim 12, further comprising determining to perform request optimization based on the first time being within a threshold time value of a start time of the optimization time window.

14. The computer-implemented method of claim 12, wherein determining whether to perform request optimization for the first user includes determining whether to automatically perform request optimization for the first user based on whether the first time is within the optimization time window.

15. The computer-implemented method of claim 11, further comprising:
in response to determining to perform request optimization, transmitting a set of content data to the user device to enable the user device to present a set of user interface features to enable the first user to either accept or decline request optimization; and
wherein request optimization for the first user is performed in response to receiving data from the user device indicating acceptance by the first user to perform request optimization.

16. The computer-implemented method of claim 15, wherein the set of user interface features includes a prompt for the first user to either accept or decline request optimization in requesting the network-based service, the prompt displaying (i) a first estimated time of arrival at the service location and a first cost for requesting the network-based service associated with accepting request optimization, and (ii) a second estimated time of arrival at the service location and a second cost for requesting the network-based service associated with declining request optimization.

17. The computer-implemented method of claim 11, further comprising:
wherein determining whether to perform request optimization for the first user includes determining whether to automatically perform request optimization for the first user; and
in response to determining to automatically perform request optimization for the first user, transmitting a set of content data to the user device to enable the user device to present a set of user interface features to request the network-based service, wherein the set of user interface features does not include a prompt for the first user to decline request optimization.

18. The computer-implemented method of claim 17, wherein the set of user interface features includes a prompt for the first user to request the network-based service, the prompt displaying an estimated time of arrival at the service location and a cost for requesting the network-based service associated with performing request optimization.

19. The computer-implemented method of claim 11, wherein determining whether to perform request optimization for the first user is based further on one or more of: (i) historical data associated with the network-based service, or (ii) user profile data associated with the first user.

20. A non-transitory computer-readable medium storing instructions that, when executed by one or more processors of a network system, cause the network system to:
receive at a first time, over a network from a user device of a first user, query data corresponding to a query for a network-based service, the query data indicating a start location and a service location;
in response to receiving the query data, determine whether to perform request optimization for the first user based, at least in part, on the start location, the service location, and the first time; and
in response to receiving a first request from the user device of the first user and based on determining to perform request optimization for the first user, perform request optimization for the first user by identifying, at a second time within an optimization time window, a service provider for the first user, wherein the service provider is identified to contemporaneously provide service for the first request and at least a second request for the network-based service from a second user.
